(19) United States
(12) Patent Application Publication
(10) Pub. No.: US 2017/0306816 A1
(43) Pub. Date: Oct. 26, 2017

(54) VENTILATION MODULE FOR AN INTERNAL COMBUSTION ENGINE

(71) Applicant: BRUSS SEALING SYSTEMS GMBH, HOISDORF (DE)

(72) Inventors: MANFRED BRAND, TREMSBUETTEL (DE); HARALD LEISNER, BARGTEHEIDE (DE); STEFAN RUST, HAMBURG (DE); ROLAND KRAL, SEEVETAL (DE); THOMAS SCHRADER, HAMBURG (DE)

(73) Assignee: BRUSS SEALING SYSTEMS GMBH, HOISDORF (DE)

(21) Appl. No.: 15/517,736

(22) PCT Filed: Oct. 2, 2015
(86) PCT No.: PCT/EP2015/072811

§ 371 Date: Apr. 7, 2017

(30) Foreign Application Priority Data
Oct. 7, 2014 (EP) 14 187 950.2

(51) Int. Cl. F01M 13/04; F02F 1/24; F02F 7/00

(52) U.S. Cl. CPC F01M 13/04; F02F 7/006; F01M 2013/0494; F02F 1/24

(57) ABSTRACT

A venting module for an internal combustion engine comprises an oil separator with an oil return line, and a check valve which is arranged in the oil return line. The check valve comprises a valve housing, a valve body which is held in the valve housing such that it can be displaced as an entirety between an open position and a closed position, wherein the valve body is held in the open position without prestress and as a result of gravity in the rest state of the internal combustion engine. During operation of the internal combustion engine, the valve body is in the open position independently of the prevailing gas pressure if a defined liquid level in the valve housing is not exceeded, and the valve body is set up for automatic displacement into the closed position as a result of buoyancy if a defined liquid level in the valve housing is exceeded. The venting module has a sealing element which seals the oil return line and is arranged with compression between the venting module and the engine when the venting module is mounted.

The invention relates to a ventilation module for an internal combustion engine, including an oil separator comprising an oil return and a non-return valve inserted into the oil return.

A non-return valve as safety valve for an oil return below the oil level is supposed to prevent the oil from being sucked for example out of the oil pan into the cleanroom in the case of possibly occurring sudden very high pressure differences.

High pressure differences occur for example when the separator is clogged or frozen and upon sudden vaporization of ethanol (fuel component). Driving short distance may cause ethanol to accumulate in the oil; when the vaporization temperature (about 78° C.) is exceeded, it vaporizes almost immediately. The now gaseous ethanol causes a short but very high increase in the blow-by amount which may then induce a very high pressure loss in the separator.

Furthermore, the non-return valve during normal operation is supposed to ensure an unhindered discharge of the oil for example into the oil pan.

An open oil return runs the risk of uncleaned gas getting into the cleanroom of the oil separator via the return. To make things worse, the gas flowing in through the return entrains already separated oil.

To avoid these problems, different designs of non-return valves are known.

Common types of non-return valves for example comprise an umbrella-shaped or plate-shaped elastomer body which in the idle position of the engine is in the closed position and in the case of a low pressure in the crankcase and/or at a predetermined filling level in an oil reservoir opens automatically, see U.S. Pat. No. 4,602,595; WO 12 32955 A1; DE 10 2004 002 310 A1; DE 20 2004 004 803 U1, FIG. 14; WO 2004 090292 A2. This design runs the risk of freezing in the non-operated state of the engine, as the oil cannot discharge.

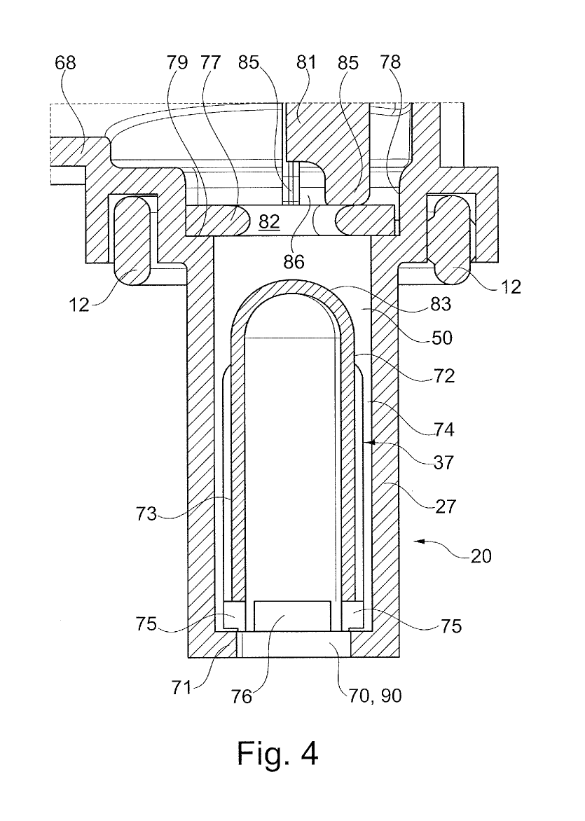

The like applies to conventional flexible-tongue valves which in the idle position of the engine are in the closed position and in the case of a low pressure in the crankcase and/or at a predetermined filling level in an oil reservoir open automatically, see DE 10 2004 061 938 B3; EP 1 614 871 A2; DE 10 2006 038 700 A1, FIG. 4; DE 10 2007 017 235 A1; DE 10 2007 058 059 A1; DE 10 2007 008 672 A1; DE 10 2008 019 293 A1.

The spring diaphragm according to DE 296 05 425 U1 in the unloaded state owing to its own weight in fact is in an open position. However, the spring diaphragm in the open position hangs down loose so that the open position is not well-defined. For example, the flexible tongue cannot be prevented from sagging due to aging or high stress, being a potential risk to the operational capability of the non-return valve.

DE 20 2007 011 585 U1 discloses an oil return valve comprising a float body located in a housing, which float body due to buoyant lift clears a discharge opening in the housing when a defined oil level is exceeded and due to gravity closes said opening when the oil level falls below a defined oil level. EP 1 090 210 B1 discloses a cyclone separator comprising a valve ball located in the oil return, which valve ball due to gravity closes the oil return in the non-operated state of the engine.

All of the aforementioned non-return valves have in common that in the non-operated state of the engine they do not provide the maximum opening cross section, being detrimental to the freezing behavior and resulting in a slower discharge of the oil.

Another design provides a controlled non-return valve which is opened in a pilot-operated manner by use of external power, for example compressed air or magnetic force, see DE 195 15 482 A1; DE 202 17 601 U1; DE 203 02 911 U1; DE 10 2004 018 567 B3. However, the realization of such pilot-operated valves is very complex. The same applies to flexible-tongue valves controlled by a pump according to DE 20 2004 004 902 U1 and DE 10 2008 019 293 A1.

An oil separation system comprising an oil return non-return valve is known from DE 196 28 812 B4. The non-return valve includes a housing and a valve body which is mounted so as to be movable as a whole within the housing, the valve body in the non-operated state of the engine clearing a maximum opening cross section and during operation in the case of an overpressure in the crankcase being lifted relative to the oil separator in a pressure-operated manner, resulting in an upper through opening being closed. On its outer circumference, the housing comprises at least one sealing lip to be inserted tightly into a return line for separated oil leading from the oil separation filter to the crankcase. In this oil separation system, the oil separation filter and the non-return valve are separate units and do not form a common ventilation module.

Like with other conventional ball valves and diaphragm valves, another problem is that the valve closes already in the case of slight pressure differences which may occur frequently even during normal engine operation due to pressure vibrations. An oil film between the upper valve seat or the valve housing and the valve body prevents a pressure compensation of the room above and the room below the valve body, which is why the valve closes and might stay in the closed position during the further engine operation, and thus prevents the separated oil from discharging. Furthermore, there are two wall thicknesses in the valve area, namely, the thickness of the walls of the valve housing and the thickness of the walls forming the oil return, resulting in an accordingly large overall size of the valve.

DE 10 2006 018 783 A1 discloses a valve in a crankcase ventilation system comprising an oil accumulation chamber, the discharge opening of which can be closed by a valve plate. A valve cage is located on the oil accumulation chamber preventing the valve plate from slipping out. Below the valve cage, a float is located which is guided in an axially displaceable manner by four webs formed from a carrier housing. The valve and the float are located in the carrier housing. If oil ascends from the crankcase into the oil return line, the float moves upwards and pushes against the valve plate to move the valve plate upwards to the closed position so that the valve closes again despite the lack of differential pressure. As soon as the valve is closed, the pressure in the oil accumulation chamber can no longer continue into the oil line, but builds up again within the oil accumulation chamber. Upon opening the valve, the oil thus can discharge again, and the pressure ratios stabilize again. The valve includes a plurality of separate parts (valve disc, valve cage, float, carrier housing) and is very large in size. Moreover, in this arrangement the separated oil flows back into the oil sump through channels ending above the oil level. Therefore, in the case of overpressure in the crankcase the valve may undesirably close, preventing the oil from discharging.

DE 42 14 324 A1 discloses a cyclone separator for the crankcase ventilation comprising a float valve located in the oil discharge. If the pressure differences occurring between the pressure in the cyclone and the pressure in the crankcase are so high that oil ascends in the downpipe from the oil sump up to the cyclone, the closing float valve prevents the ingress of oil into the funnel of the cyclone. A discharge nozzle for connecting a hose line is provided below the float valve. The discharge nozzle and the hose line are additional components. The connections between discharge nozzle and cyclone on the one hand, and between discharge nozzle and hose line, and also the hose line itself pose potential leakages for oil ascending in the return line so that oil might get into the cylinder head and, in the worst case, might get outside.

It is the object of the invention to provide a ventilation module comprising a simple non-return valve being compact in size, where under all operating conditions the most continuous oil return possible from the cleanroom into the dirt-holding space is ensured and disadvantages caused by oil ascending in the return line are prevented.

The invention solves this object with the features of the independent claims. According to the invention, the valve is designed in such a way that, irrespective of the drop in gas pressure above the valve, and in particular irrespective of the gas pressures in the crankcase and in the cleanroom of the oil separator, the valve body stays in the open position if and as long as a defined oil level in the valve housing is not exceeded. This feature of the invention ensures a continuous oil return basically under all operating conditions of the engine. Furthermore, the valve body is automatically moved to the closed position by buoyant lift if and as long as a defined oil level in the valve housing is exceeded. This feature of the invention ensures that the non-return function is realized reliably.

According to the invention, the oil separator and the non-return valve are integrated in a ventilation module. With other words, the non-return valve is no separate component but is part of the ventilation module which also includes the oil separator. In particular, the oil separator and the non-return valve are connected to each other in an oil-tight manner in the ventilation module so that from the oil separator oil can get into the non-return valve through the oil return only.

According to the invention, the ventilation module includes a sealing element which seals the oil return, and which is press-fitted between the ventilation module and an engine component when the ventilation module is mounted. According to the invention, oil ascending in the return line thus cannot leak out of the oil return at the junction between ventilation module and engine. The ventilation module and the engine component are sealed via the sealing element directly and advantageously in contact with each other. According to the invention, a leakage-susceptible hose line between the ventilation module and the engine and corresponding fastening means as for example described in DE 42 14 324 A1 are no longer needed.

According to the invention, the discharge side of the valve is to be connected to an oil return line ending below an oil level. Thus, the non-return valve only closes in the case of oil ascending in the oil return line to prevent the ingress of oil into the cleanroom. An undesired closing of the valve in the case of overpressure in the crankcase will not occur. The return line below the oil level takes over the closing of the return line and eliminates a bypass of the separator.

Preferably, a separate orifice comprising a through opening is located at the inlet side of the valve, which orifice forms a valve seat for the valve body and bears against the valve housing. Designing the valve seat as a separate orifice provides the advantage that the material of the valve seat can be adapted to the material of the valve body. In particular, a quasi-isotropic material or a material that is isotropic with respect to shrinkage, preferably a non-reinforced or ball-reinforced thermoplastic, can be chosen so that valve seat and valve body stay round and are still able to seal to each other even upon shrinkage due to aging or production. Using a separate orifice allows to choose another suitable material for the cover, for example glass fiber-reinforced plastic.

In the following the invention is described on the basis of preferred embodiments with reference to the accompanying figures. The figures show:

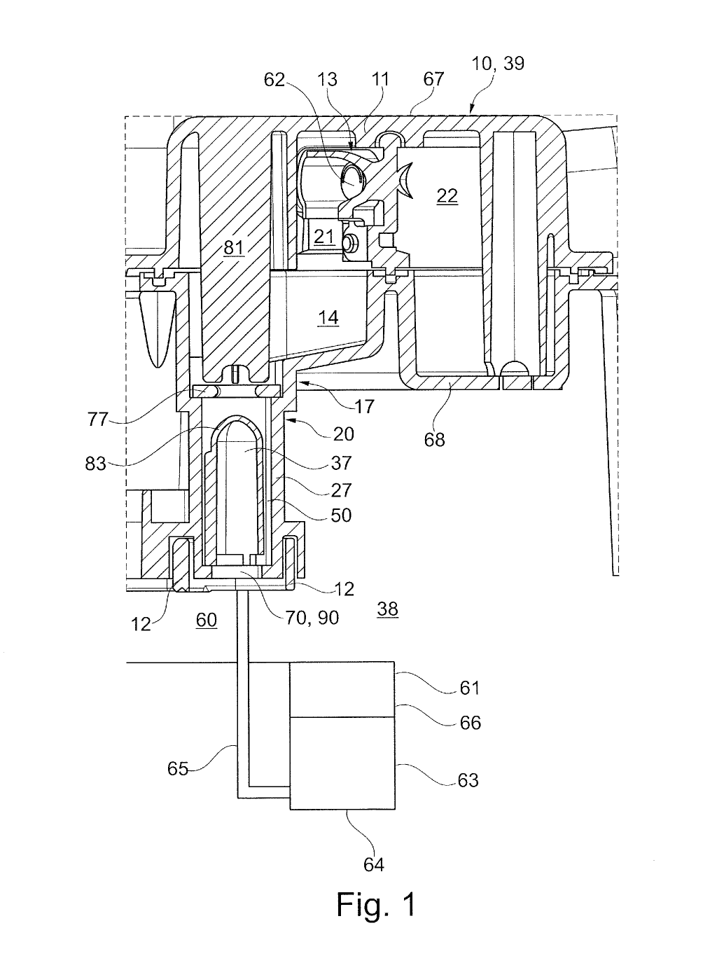

FIG. 1 a schematic view of a system for crankcase ventilation of an internal combustion engine;

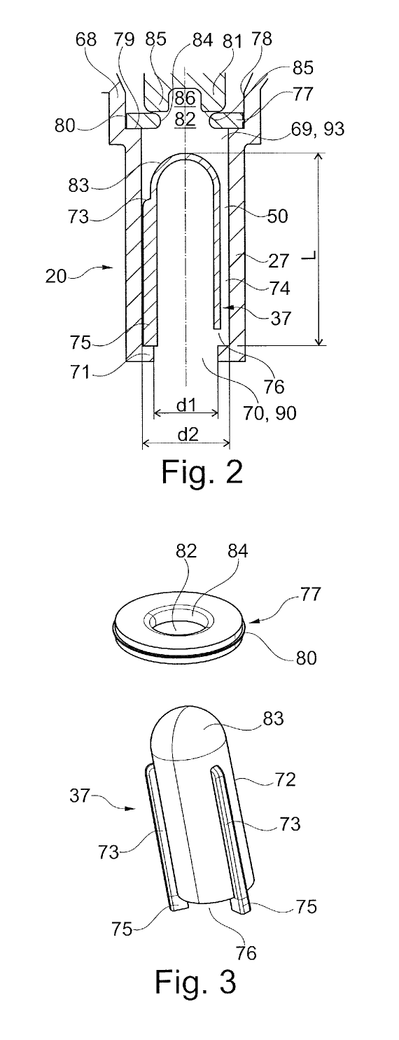

FIG. 2 a cross section through an inventive non-return valve;

FIG. 3 a perspective exploded view of a valve body and an orifice;

FIG. 4 a further cross-sectional view of an inventive non-return valve;

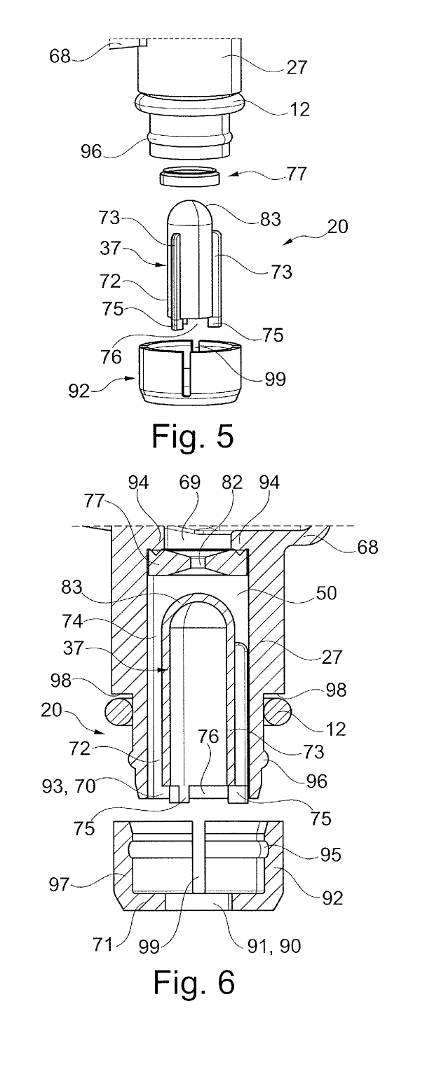

FIG. 5 a perspective exploded view of a non-return valve in a further embodiment;

FIG. 6, 7 cross-sectional views of the non-return valve in the embodiment according to FIG. 5; and

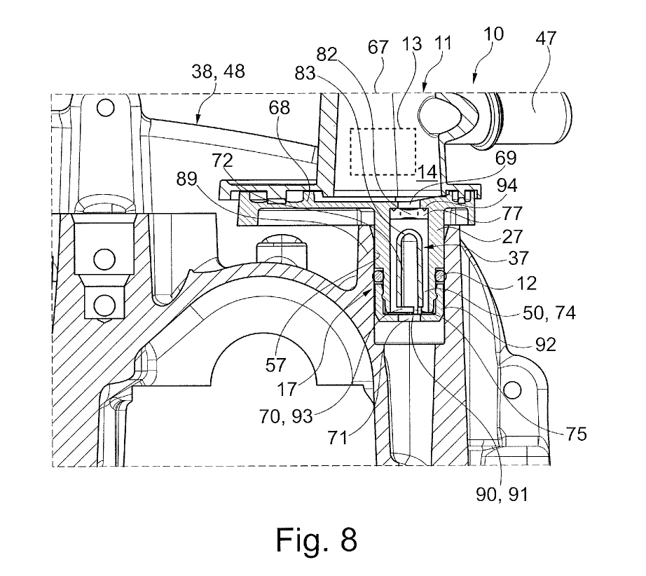

FIG. 8 a cross-sectional view of a non-return valve in a third embodiment.

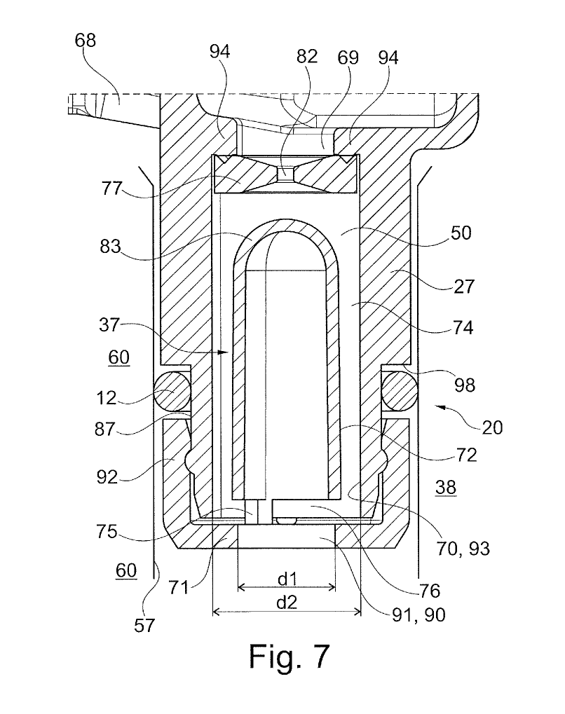

In the embodiments according to FIGS. 1 to 7, the ventilation module 10 for example is a cylinder head cover 39. The ventilation module 10 shown in sections in a cross-sectional view in FIG. 1 includes a housing 11 which for example is made from a thermoplastic. The housing 11 includes for example an upper housing part 67 and a lower housing part 68. In the ventilation module 10, at least one oil separator 13 is located, here for example a spring-tongue separator comprising a flexible tongue 62, to which separator blow-by gases from the crankcase 61 of the internal combustion engine are fed at a gas inlet side 22. The cleaned gas from the oil separator 13 gets into a cleanroom 21 in the ventilation module 10, and from there via a gas outlet 47 is fed for example into the intake section of the internal combustion engine. The separated oil can be accumulated in an accumulation chamber 14 and via an oil return 17 is fed back into the oil sump 63 of the crankcase 61 or rather of the oil pan 64. The oil return 17 ends in an oil discharge opening 90 of the non-return valve 20 and accordingly of the ventilation module 10. From the oil discharge opening 90, the discharging oil via an oil return line 65 gets into the oil sump 63 into the crankcase 61 or rather the oil pan 64. The oil return line 65 ends below an oil level. This may be the oil level 66 in the oil sump 63 in the crankcase 61 or rather of the oil pan 64. However, it may also be an oil level between the oil discharge opening 90 and the oil sump 63, for example of a siphon in the cylinder head 60.

A non-return valve 20 is located in the oil return 17. The non-return valve 20 is part of the ventilation module 10, here of the cylinder head cover 39, and is located inside the ventilation module. The non-return valve 20 includes a tubular valve housing 27 forming a chamber 50 for a longish valve body 37 which is preferably open towards the bottom.

The valve housing 27 is preferably formed integrally from the housing 11 of the ventilation module 10, in particular from the lower housing part 68. A separate valve housing then is no longer needed, with the result that the number of parts can be reduced and the mounting process can be shortened because a corresponding connecting step is no longer needed. Moreover, the valve 20, compared to the prior art comprising a separate valve housing, is smaller by one wall thickness. The valve housing 27 can also be formed integrally from the upper housing part 67 of the housing 11 of the ventilation module 10.

The valve housing 27 is preferably open towards the top and towards the bottom. In the embodiment of FIGS. 2 to 4, the valve body 37 is inserted into the valve housing 27 from above. The upper opening 69 in the valve housing 27 thus forms the mounting opening 93 of the valve 20. In the embodiments of FIGS. 5 to 8, the valve body 37 is inserted into the valve housing 27 from below. So in this case, the lower opening 70 of the valve housing 27 forms the mounting opening 93 of the valve 20. The diameter of the mounting opening 93 of the valve housing 27 advantageously corresponds to the diameter d2 of the chamber 50 so that the valve body 37 can be inserted through the mounting opening 93 from above or from below. The diameter d2 of the chamber 50 is preferably in the range between 6 mm and 16 mm. The ratio of length L of the valve body 37 to the diameter d2 of the chamber 50 is preferably at least two.

In the embodiment of FIGS. 2 to 4, the lower opening 70 of the valve housing 27 forms the oil discharge opening 90 of the ventilation module 10, here of the cylinder head cover 39. In the embodiments of FIGS. 5 to 8, the outlet opening 91 of the lid 92 to be described below forms the oil discharge opening 90 of the ventilation module 10.

The diameter d1 of the oil discharge opening 90 advantageously at least partially is smaller than the diameter d2 of the chamber 50. This can be realized for example by an inwardly-protruding ring-shaped collar 71 at the lower end of the valve housing 27 and of the lid 92, respectively. The diameter d1 of the oil discharge opening 90 is preferably in the range between 5 mm and 11 mm. The ratio of length L of the valve body 37 to the diameter d1 of the oil discharge opening 90 is preferably at least two, further preferably at least 2.5, for example about 3. The mentioned values or value ranges are adapted optimally to the requirements of the oil return in the crankcase ventilation.

The valve body 37 includes a cylindrical base body 72, the outer diameter of which is smaller than the inner diameter d2 of the chamber 50 so that in the annular gap 74 which is preferably at least 0.75 mm, further preferably at least 1 mm, and which is formed between the base body 72 and the chamber 50 oil can discharge downwards at any time. On the outer circumference of the base body 72, a plurality of for example three axial wings 73 is provided (not visible in FIG. 8 due to the section), which wings preferably are distributed equidistantly over the circumference of the base body 72. The radial dimensions of the wings 73 are chosen in such a way that the outer diameter of the valve body 37 which in particular is defined by the wings 73 is smaller than the inner diameter d2 of the chamber 50 or rather of the valve housing 27, and plus clearance corresponds to the inner diameter d2 of the chamber 50 or rather of the valve housing 27. The radial projection of the wings 73, in particular beyond the cylindrical base body 72, thus essentially corresponds to the width of the annular gap 74. The wings 73 hold the valve body 37 in a defined position, in particular in the center of the chamber 50, and form the annular gap 74 between the valve housing 27 and the valve body 37.

At least one spacer 75 is preferably provided at the lower end of the valve body 37 to keep the base body 72 spaced from the oil discharge opening 90. In the present embodiments, a plurality of spacers 75 is provided which conveniently are designed as prolongations of the wings 73. The spacers 75 for example rest on the collar 71 of the valve housing 27 and of the lid 92, respectively. Between the spacers 75, corresponding free spaces 76 are formed so that oil can discharge unhindered through the gap 74, the free spaces 76 and the discharge opening 90 when the valve body 37 is in the lower position. The spacer 75 or the spacers 75 may also be formed as upwardly-protruding elements in the collar 71.

A ring-shaped orifice 77 forming an upper abutment and a valve seat for the valve body 37 is provided at the upper end of the valve housing 27. The orifice 77 is preferably a separate component, in particular the valve housing 27 and the orifice 77 are separate components. The orifice 77 includes an especially concentric inner through opening 82. At its upper end, the valve body 37 is closed by a cap 83 which closes the opening 82 of the orifice 77 against oil passage when the valve body 37 is in the upper abutting position. Thus, the diameter of the cap 83 conveniently is larger than the inner diameter of the opening 82 of the orifice 77. The cap 83 of the valve body 37 advantageously can be rounded and for example can have a semispherical shape. The inner wall 84 of the orifice 77 forming the opening 82 advantageously can also be rounded, in particular to realize an optimal interaction with the rounded cap 83.

For mounting the orifice 77, the embodiment according to FIGS. 2 to 4 provides a recess 78 in the lower housing shell 68, into which recess the orifice 77 can be inserted from above. The inner diameter of the recess 78 advantageously is larger than the inner diameter d2 of the chamber 50 so that the valve housing 27 forms a projection 79 bearing the orifice 77. The inner diameter of the recess 78 preferably corresponds to the outer diameter of the orifice 77.

The outer circumference of the orifice 77 preferably has a cylindrical shape. In the embodiment according to FIGS. 2 to 4, advantageously at least one circumferential sealing edge 80 is provided on the circumference of the orifice 77, the outer diameter of which is slightly larger than the inner diameter of the recess 78. The orifice 77 is press-fitted into the recess 78 so that the sealing edge 80 sealingly interacts with the recess 78 through deformation. As a precaution, the orifice 77 can be retained in the operational position shown in FIG. 1, FIG. 2 and FIG. 4 by a downholder 81 which may be integrally molded to the housing 11, for example to the upper housing shell 67. At its lower end, the downholder 81 includes webs 85 which act on the orifice 77, and free spaces 86 formed between the webs through which oil from the outside can discharge inside through the downholder 81 and through the opening 82 of the orifice 77 described below.

In the embodiments according to FIGS. 5 to 8, the orifice 77 is inserted into the valve chamber 50 from below. Here, the diameter of the upper opening 69 of the valve chamber 50 is preferably smaller than the diameter of the orifice 77 so that the orifice 77 bears against the bottom of an annular projection 94 of the valve housing 27, which annular projection forms the upper opening 69, see FIGS. 6 to 8. To prevent the orifice 77 from falling down and to seal the valve chamber 50 towards the accumulation chamber 14, the orifice 77 advantageously is sealingly connected to the valve housing 27 at the upper end of the chamber 50, for example welded. The combination of orifice 77/valve body 37 closes the valve housing 27 towards the top when the valve body 37 is buoyed up. Alternatively, the orifice 77 can also be sealingly press-fitted into the valve chamber 50 from below or can be fastened for example by screwing means or adhesive means.

In the embodiments according to FIGS. 5 to 8, a securing element 92 is provided at the lower end of the valve chamber 50 preventing the valve body 37 from falling down out of the valve chamber 50. The securing element 92 preferably has the shape of a lid comprising a cylindrical part 97 with which the lid 92 can be slid or pulled over the valve housing 27 from outside, and a central opening 91, with the ring-shaped collar 71 which forms the opening 91 forming a supporting surface or rather a lower abutment for the valve body 37, for example for the spacers 75.

Preferably, a notch means 95 engagingly interacting with a corresponding latch means 96 on the valve housing 27 is provided on the securing element 92. The notch means 95 is preferably an annular groove on the inner circumference of the cylindrical part 97 of the lid 92. The latch means 96 is preferably an annular bead or bar on the outer circumference of the valve housing 27. Of course, the bar 96 can also be provided on the lid 92, and the notch groove 95 can be provided on the valve housing 27. Differently shaped notch/latch means are possible. Instead of the notch means 95 and the latch means 96, also other connecting means between the securing element 92 and the valve housing 27 are possible, for example screw means or adhesive means. According to the aforesaid, the securing means 92 preferably is connected or can be connected detachably to the valve housing 27.

The valve 20 and accordingly the oil return 17 is sealed towards an adjacent engine component 38, in FIGS. 1 to 7 towards the cylinder head 60, in FIG. 8 towards a so-called closed cam carrier 48, by a sealing element 12. In the embodiment according to FIGS. 1 to 4, a mounting 49 for a sealing element 12 is formed at the lower end of the valve housing 27 with which sealing element the valve housing 27 is sealed to the bottom towards the cylinder head (axial seal in relation to the length axis of the valve 20). In the embodiments according to FIGS. 5 to 8, the sealing element 12 is preferably a sealing ring which is arranged around the valve housing 27 preferably in contact with the same (radial seal). Here, the sealing ring 12 seals the valve 20 towards a bore 57 in the engine component 38 (see FIG. 8), into which bore the valve 20 or rather the valve housing 27 can be sealingly inserted.

Advantageously, a radial offset 98 is provided on the valve housing 27 (see FIG. 6) so that in the mounted state a groove 87, in particular a circumferential groove, is formed axially between the offset 98 and the securing means 92 for mounting the sealing ring 12. The advantage of the lid 92 forming the groove 87 is that the counterpart comprising the bead in the axial direction of the valve 20 is deflashed by force and no flash resulting from mold parting interrupts or disrupts the radial sealing path of the sealing ring 12 on the valve 20. The notch groove 95 in the lid 92 can also be deflashed by force. In the cylindrical part 97 of the lid 92, preferably axial slits 99 are provided facilitating the mounting of the lid 92. Alternatively, the groove 87 can also be provided in the valve housing 27.

In the mounted state, the sealing element 12 is press-fitted between the ventilation module 10, in particular the valve 20 or rather the valve housing 27, and the engine component 38. With other words, the distance between the ventilation module 10 and the engine component 38 in the area of the sealing element 12 in the mounted state is smaller than the expansion of the sealing element so that the sealing effect of the sealing element is produced by its deformation.

The sealing element 12 serves as a local seal of the oil return 17 at the junction between the ventilation module 10 and the adjacent engine component 38, in particular in the direction opposite to the returning direction. Local seal means that the sealing element 12 advantageously does not seal any other through opening between the ventilation module 10 and the adjacent engine component 38, and in particular does not surround the gas inlet for the intake of the blow-by gases into the ventilation module 10 for which advantageously a separate sealing element is provided. The circumference of the sealing element 12 is preferably not exceeding ½, further preferably not exceeding ⅓, even further preferably not exceeding ¼ of the circumference of the ventilation module 10 in the plane of the sealing element 12. The circumference of the sealing element 12 is preferably not exceeding four times, further preferably not exceeding three times, even further preferably not exceeding twice, even further preferably not exceeding one and a half times the circumference of the oil return opening 74 in the plane of the sealing element 12.

Advantageously, the valve body 37 is formed integrally from a quasi-isotropic material or a material that is isotropic with respect to shrinkage, in particular a non-reinforced thermoplastic or a glass ball-reinforced plastic. The orifice 77 is preferably formed integrally from the same material as the valve body 37. The valve housing 27 is made from a suitable material, in particular from a material that is different from the material of the orifice 77, for example a fiber-reinforced thermoplastic.

In the embodiment according to FIG. 8, the engine component 38 is formed by a cover 48 named closed cam carrier to be put on the cylinder head 60, which cover due to high operational temperatures advantageously is made from metal, in particular aluminum, and which also includes the camshafts. Equipping such covers 48 with ventilation, if at all possible, involves great efforts. Thus, a separate ventilation module 10 is connected to the cover 48, attachment points and through passages for the gas inlet and the oil return being provided on the cover as junction to the ventilation module 10. The gas inlet is sealed locally by a not-shown sealing element, and the oil return 17 is sealed locally by the sealing element 12 as described above. The gas feed to the ventilation module 10 alternatively can also be carried out by a hose, just as the discharge of the clean gas from the tube-shaped clean gas outlet 47.

In the embodiment according to FIG. 8, the separator 13, which is only illustrated schematically in FIG. 8, is located in the internal space of the ventilation module 10 formed between the housing parts 67, 68. The housing 11 here forms a separator housing and, for example, can be made from plastic. As can be seen from FIG. 8, the separator housing 11 and the oil separator 13 are located on top of the closed cam carrier 48. The valve housing 27 is formed integrally from the housing 11 or rather a housing part 67 of the ventilation module 10 involving the described advantages. The valve housing 27 is inserted from above into a tube-shaped mounting 89 in the engine component 38 forming the bore 57, i.e. the closed cam carrier 48, and is sealed towards the tube-shaped mounting 89 by the sealing ring 12. The orifice 77 and the valve housing 27 or rather the housing part 68 preferably are separate components.

The engine component 38, towards which the non-return valve 20 is sealed by the sealing element 12, is not limited to a cylinder head 60 or a closed cam carrier 48. In a not-shown embodiment, for example a ventilation module 10 is designed to be attached to a so-called front cover, i.e. a cover on one side, here the front side, of the engine.

In the case of the embodiment according to FIGS. 2 to 4, for mounting the valve 20 the valve body 37 is inserted freely from above into the valve housing 27 through the mounting opening 90. Subsequently, the orifice 77 is inserted freely into the recess 78 of the lower housing shell 68 of the cylinder head cover 39. Finally, the upper housing shell 67 is fitted onto the lower housing shell 68 and is connected thereto, the orifice 77 being retained in the operational position owing to the downholder 81.

In the case of the embodiment according to FIGS. 5 to 8, for mounting the valve 20 the orifice 77 is pushed freely from below into the valve housing 27 up to the abutment on the upper end, i.e. on the collar-shaped annular projection 94, and there is connected to the valve housing 27, for example by welding. Subsequently, the valve body 37 is inserted freely from below through the mounting opening 70 into the valve housing 27. The sealing ring 12 is mounted, and then the securing element 92 is pulled over the valve housing 27 from below, until the notch means 95 and latch means 96 engage into each other in a latching manner.

Dismounting the valve 20 according to FIGS. 5 to 8 is carried out in reversed order of the mounting: pulling off the securing means 92 from the valve housing 27, freely removing the valve body 37 from the valve housing 27 at the bottom, if applicable releasing and removing the orifice 77 from the valve housing 27 at the bottom, dismounting the sealing ring 12.

The functioning of the non-return valve 20 is described hereafter.

In the non-operated state of the internal combustion engine and in the normal operational position shown in FIGS. 1, 2, 3, 7 and 8, the valve body 37 due to gravity is in the lower position in which the spacers 75 rest on the collar 71. In this open position of the valve 20, oil separated by the oil separator 13 can flow through the opening 82 of the orifice 77, the gap 74, the free spaces 76 and the oil discharge opening 90 via the oil return line back into the oil sump 63 in the crankcase 61 or rather of the oil pan 64. As long as no liquid-related buoyancy forces are acting on the valve body 37, the valve body 37 stays in this operational position irrespective of the current gas pressures, in particular even in the case of the maximum pressure difference between the crankcase 61 and the cleanroom 21 occurring during operation of the internal combustion engine.

The valve body 37 as a whole is moved upwards in case oil ascends in the oil return line 65 and the liquid level in the valve chamber 50 exceeds a critical level and applies a buoyancy force to the valve body 37. The valve body 37 is moved upwards by liquid buoyancy only; the valve 20 thus is liquid-operated and not gas pressure-operated. In other words, the non-return valve 20 is a float valve, as the position of the valve body 37 is controlled by the liquid level in the valve chamber 20 only. The valve body 37 thus can also be called buoyancy body. As the valve body 37 also forms the float body, the valve 20 includes only one part that is movable during operation, namely the valve body 37. This distinguishes the inventive valve 20 from the large-sized valve according to DE 10 2006 018 783 A1, in which the valve body (valve plate) and the float are separate components which are each movable independent of each other, and between which a valve cage is further located.

The buoyant lift of the valve body 37 is terminated by the valve body 37 abutting on the orifice 77. In this closed position of the valve 20, the valve cap 83 sealingly bears against the orifice 77 and a further rise of oil and ingress into the cleanroom 21 is prevented. The hollow space volume of the valve body 37 advantageously is chosen in such a way that the valve body 37 at a 15% oil charge, preferably at a 20% oil charge, further preferably at a 25% oil charge still provokes sufficient buoyant lift to close the valve 20.

The inner diameter of the orifice opening 82 is chosen to be small enough so that the valve body 37, starting from the closed position, even in the case of the maximum pressure difference between the crankcase 61 and the cleanroom 21 occurring during operation of the internal combustion engine, and additionally against the retaining force of an oil film between the valve body 37 and the orifice 77, due to gravity falls back down again to the open position as soon as the oil level descends and liquid-related buoyancy forces are no longer acting on the valve body 37. In this way, it is ensured that the valve 20 is only closed in case oil ascends through the oil return line 65 up into the valve chamber 50, and only stays closed as long as a predetermined oil level in the valve chamber 50 is exceeded. In all other operating conditions of the internal combustion engine, in particular also in the case of pressure vibrations or in the case of a low pressure in the cleanroom 21 relative to the crankcase 61, the valve 20 stays in the open position and the separated oil can discharge. The clear cross-sectional surface of the upper opening 82 is preferably significantly smaller than the cross-sectional surface of the discharge opening 90, and advantageously is smaller than 30 mm², further preferably smaller than 20 mm², even further preferably smaller than 10 mm² and particularly advantageously is in the range between 3 mm² and 7 mm². The diameter of the upper opening 82 is preferably significantly smaller than the diameter of the discharge opening 90 and advantageously is smaller than 10 mm, further preferably smaller than 7 mm, even further preferably not exceeding 5 mm and particularly advantageously is in the range between 2 mm and 3 mm.

Due to the oil return line 65 advantageously ending below an oil level, in particular below the oil level 66 of the oil sump 63, it is realized that in the case of an overpressure in the crankcase 61, the overpressure is not applied to the discharge opening 90 of the non-return valve 20 so that even in the case of the maximum overpressure occurring in the crankcase 61 the valve body 37 stays in the open position. A higher pressure in the crankcase 61 relative to the cleanroom 21 is reduced via the hydrostatic pressure of the oil column in the return line 65.

According to the aforesaid, the oil discharge valve 20 is operated by gravity and liquid buoyancy only, but without electric or magnetic external power. The valve 20 thus advantageously is uncontrolled, non-magnetic and non-electric.

1. A ventilation module for an internal combustion engine, comprising:
a housing;
an oil separator,
wherein the oil separator comprises:
an oil return; and
a non-return valve,
wherein the non-return valve is located in the oil return,
wherein the non-return valve includes comprises:
a valve housing,
wherein the valve housing is formed integrally from the housing; and
a valve body,
wherein the valve body-which is mounted in the valve housing so as to be movable as a whole between an open position and a closed position,
wherein the valve body, when the internal combustion engine is in a non-operated state, is maintained in the open position due to gravity and free from preloads,
wherein the valve body, when the internal combustion engine is in operation, is in the open position irrespective of an applied gas pressure when a defined liquid level in the valve housing is not exceeded, and
wherein the valve body is configured to automatically move to the closed position due to buoyant force when the defined liquid level in the valve housing is exceeded, and
wherein a discharge side of the non-return valve is configured to be connected to an oil return line ending below an oil level; and
a sealing element,
wherein the sealing element seals the oil return, and
wherein the sealing element is press-fitted between the ventilation module and an engine component when the ventilation module is mounted.

2. The ventilation module according to claim 1,
wherein a separate orifice comprising a through opening is located at an inlet side of the non-return valve, and
wherein the separate orifice forms a valve seat for the valve body.

3. The ventilation module according to claim 2,
wherein the separate orifice bears against the valve housing.

4. The ventilation module according to claim 2,
wherein a diameter of the separate orifice is small enough so that gravity acting on the valve body is greater than a sum of a maximum suction force and a maximum retaining force by an oil film.

5. The ventilation module according to claim 2,
wherein the separate orifice comprises;
at least one sealing edge on an outer circumference of the separate orifice,
wherein the at least one sealing edge sealingly interacts with the valve housing through deformation.

6. The ventilation module according to claim 2, further comprising:
a downholder,
wherein the downholder retains the separate orifice in an operational position.

7. The ventilation module according to one claim 2,
wherein the separate orifice and/or the valve body are made from a non-reinforced or ball-reinforced thermoplastic.

8. The ventilation module according to claim 1,
wherein the valve body is freely insertable into, and is freely removable from, the valve housing at a discharge end of the valve housing.

9. The ventilation module according to claim 1, further comprising:
a lid,
wherein the lid is attached to a discharge end of the valve housing.

10. The ventilation module according to claim 9,
wherein the lid is a lid which can be pulled over the discharge end of the valve housing.

11. The ventilation module according to claim 9,
wherein a radial offset is provided on the valve housing, and
wherein a groove is formed axially between the radial offset and the lid for mounting the sealing element.

12. (canceled)

13. The ventilation module according to claim 1, further comprising:
axial wings,
wherein the axial wings are on the valve body and/or on the valve housing, and
wherein the axial wings hold the valve body in a defined position in the valve housing.

14. The ventilation module according to claim 1,
wherein the valve body is open towards a discharge end of the valve housing, and
wherein hollow space volume of the valve body is such that the valve body at a 15% oil charge still provokes sufficient buoyant force to move the valve body to the closed position.

15. The ventilation module according to claim 1,
wherein the engine component is a cylinder head, a closed cam carrier, or a cover on one side of the internal combustion engine.

16. The ventilation module according to claim 2,
wherein the valve body is freely insertable into, and is freely removable from, the valve housing at a discharge end of the valve housing.

17. The ventilation module according to claim 2, further comprising:
a lid,
wherein the lid is attached to the discharge end of the valve housing.

18. The ventilation module according to claim 17,
wherein the lid is a lid which can be pulled over the discharge end of the valve housing.

19. The ventilation module according to claim 17,
wherein a radial offset is provided on the valve housing, and
wherein a groove is formed axially between the radial offset and the lid for mounting the sealing element.
